(19) United States
(12) Patent Application Publication
(10) Pub. No.: US 2026/0339228 A1
(43) Pub. Date: Oct. 29, 2026

(54) TONER, METHOD FOR PRODUCING TONER, TONER CONTAINER UNIT, IMAGE FORMING APPARATUS, IMAGE FORMING METHOD, AND METHOD FOR PRODUCING PRINTED MATTER

(71) Applicants: Kaede MASUKO, Shizuoka (JP); Kohtaroh OGINO, Shizuoka (JP); Hiroshi YAMADA, Shizuoka (JP); Akihiro KANEKO, Kanagawa (JP)

(72) Inventors: Kaede MASUKO, Shizuoka (JP); Kohtaroh OGINO, Shizuoka (JP); Hiroshi YAMADA, Shizuoka (JP); Akihiro KANEKO, Kanagawa (JP)

(21) Appl. No.: 19/645,344

(22) Filed: Apr. 13, 2026

(30) Foreign Application Priority Data
Apr. 24, 2025 (JP) 2025-072160

(51) Int. Cl. G03G 9/087; G03G 9/08; G03G 15/08

(52) U.S. Cl. CPC G03G 9/08755; G03G 9/081; G03G 15/0865; G03G 2215/0604

(57) ABSTRACT

A toner is provided that includes a polyester resin, a styrene resin, and a release agent. In a spectrum of the toner as determined by Fourier transform infrared spectroscopy with attenuated total reflectance, a ratio R2/R1 is not less than 0.075 and not more than 0.095 and a ratio W/R1 is not less than 0.035 and not more than 0.065, where R1 is a maximum peak height of the spectrum in a range of 743 to 890 cm⁻¹, R2 is a maximum peak height of the spectrum in a range of 685 to 711 cm⁻¹, and W is a maximum peak height of the spectrum in a range of 2834 to 2862 cm⁻¹.

### CROSS-REFERENCE TO RELATED APPLICATIONS

This patent application is based on and claims priority pursuant to 35 U.S.C. § 119 (a) to Japanese Patent Application No. 2025-072160, filed on Apr. 24, 2025, in the Japan Patent Office, the entire disclosure of which is hereby incorporated by reference herein.

### BACKGROUND

### Technical Field

The present disclosure relates to a toner, a method for producing a toner, a toner container unit, an image forming apparatus, an image forming method, and a method for producing printed matter.

### Related Art

In an image forming method using electrophotography, an electrostatic charge image (latent image) is formed on a photoconductor, and a toner image is formed by developing the obtained latent image using a toner. In order to perform favorable image formation, it is preferable that the influence of external factors on the chargeability of the toner is small. Examples of external factors include, but are not limited to, an influence caused by in-machine stress. When toner is retained in a developing section for a long period of time, deformation, cracking, or chipping of toner particles, embedding of external additives into the particle surfaces, or the like may occur. As a result, changes in particle size distribution, shape, adhesion, and fluidity of the toner may affect the chargeability of the toner, and this effect becomes particularly noticeable during printing at a low image coverage.

On the other hand, from the viewpoints of energy saving and downsizing of apparatuses such as copiers, there is a demand for a toner having a low cold-offset temperature and excellent low-temperature fixability. As a method for improving the low-temperature fixability of a toner, it is known to increase the amount of wax in the toner. However, heat-resistant storage stability deteriorates due to a large amount of wax being exposed on the toner surface.

### SUMMARY

Embodiments of the present invention provide a toner that includes a polyester resin, a styrene resin, and a release agent. In a spectrum of the toner as determined by Fourier transform infrared spectroscopy with attenuated total reflectance, a ratio R2/R1 is not less than 0.075 and not more than 0.095 and a ratio W/R1 is not less than 0.035 and not more than 0.065, where R1 is a maximum peak height of the spectrum in a range of 743 to 890 cm⁻¹, R2 is a maximum peak height of the spectrum in a range of 685 to 711 cm⁻¹, and W is a maximum peak height of the spectrum in a range of 2834 to 2862 cm⁻¹.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic configuration diagram illustrating a tandem-type image forming apparatus according to an embodiment of the present invention;

FIG. 2 is a partially enlarged view of FIG. 1; and

FIG. 3 is a diagram illustrating a process cartridge as a toner container unit according to an embodiment of the present invention.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to one aspect of the present disclosure, a toner that achieves both excellent low-temperature fixability and heat-resistant storage stability is provided.

According to studies by the present inventors, when an attempt is made to achieve low-temperature fixing by increasing the amount of a release agent in a toner, a large amount of the release agent is exposed on the surface of the toner, resulting in deterioration of heat-resistant storage stability. Therefore, by adding a wax dispersant to improve the dispersibility of the release agent, the amount of the release agent exposed on the surface can be reduced even when the same amount of the release agent is incorporated into the toner. Further, the wax dispersant includes a styrene resin having a high glass transition temperature (Tg) and thus exhibits high heat resistance. Therefore, the heat resistance of the toner itself can be secured by localized distribution of the wax dispersant on the surface of toner particles. However, if the amount of the wax dispersant localized on the surface is too small, the effect of improving heat resistance cannot be obtained, whereas if the amount is too large, over-dispersion may occur and the effect of the release agent may be impaired. For this reason, the amount of the release agent localized on the surfaces and the amount of the wax dispersant on the surface within respective appropriate ranges should be designed.

As a result of intensive studies, the present inventors have found that a toner containing a polyester resin, a styrene resin, and a release agent can be provided with excellent low-temperature fixability and excellent heat-resistant storage stability while appropriately suppressing exposure of the release agent and a wax dispersant on the toner surfaces even under stress in a developing process, provided that, in a spectrum of the toner as determined by Fourier transform infrared spectroscopy with attenuated total reflectance (FTIR-ATR), a ratio R2/R1 is not less than 0.075 and not more than 0.095 and a ratio W/R1 is not less than 0.035 and not more than 0.065, where: R1 is a maximum peak height of the spectrum in a range of 743 to 890 cm⁻¹; R2 is a maximum peak height of the spectrum in a range of 685 to 711 cm⁻¹; and W is a maximum peak height of the spectrum in a range of 2834 to 2862 cm⁻¹.

Hereinafter, a toner according to an embodiment of the present invention will be described in more detail.

### (Toner)

A toner according to an embodiment of the present invention is composed of toner base particles (hereinafter, also referred to as “toner base,” or “base particles”) and an external additive.

The toner base particles include a binder resin, a wax dispersant, and a release agent, and further include a charge control agent, a colorant, and the like as necessary.

It is preferable that the toner base particles are a pulverized-type toner.

The toner according to an embodiment of the present invention may be a magnetic toner containing a magnetic material, or may be a non-magnetic toner containing no magnetic material.

### <Binder Resin>

The binder resin in the toner according to an embodiment of the present invention includes a polyester resin.

As the polyester resin, an amorphous polyester resin is preferably used.

The amorphous polyester resin is not particularly limited and can be appropriately selected depending on the intended purpose. Examples of the amorphous polyester resin include, but are not limited to, an amorphous polyester resin A and an amorphous polyester resin B, which will be described below.

### —Amorphous Polyester Resin A—

The amorphous polyester resin A is not particularly limited and can be appropriately selected depending on the intended purpose but preferably has a glass transition temperature (Tg) of not less than −40 °C and not more than 20 °C.

The amorphous polyester resin A is not particularly limited and can be appropriately selected depending on the intended purpose, but is preferably obtained by a reaction between a non-linear reactive precursor and a curing agent.

Further, the amorphous polyester resin A preferably has at least one selected from the group consisting of a urethane bond and a urea bond in view of its excellent adhesiveness to a recording medium such as paper. By having at least one selected from the group consisting of a urethane bond and a urea bond, the amorphous polyester resin A can exhibit a urethane bond or a urea bond that behaves as a pseudo-crosslinking point, thereby enhancing the rubber-like properties of the amorphous polyester resin A. As a result, the heat-resistant storage stability and high-temperature offset resistance of the toner are excellent.

### —Non-linear Reactive Precursor—

The non-linear reactive precursor is not particularly limited, and any polyester resin having a group that can react with the curing agent (hereinafter, sometimes referred to as a “prepolymer”) may be appropriately selected depending on the intended purpose.

Examples of a group in the prepolymer that can react with the curing agent includes, but are not limited to, a group that can react with active hydrogen groups. Examples of groups that can react with the active hydrogen groups include, but are not limited to, an isocyanate group, an epoxy group, a carboxylic acid, and an acid chloride group. Among these, an isocyanate group is preferable in that a urethane bond or a urea bond can be introduced into the amorphous polyester resin.

The prepolymer has a non-linear structure. The term “non-linear” means having a branched structure imparted by at least one selected from the group consisting of an alcohol having a functionality of three or more and a carboxylic acid having a functionality of three or more.

Further, as the prepolymer, a polyester resin containing an isocyanate group is preferable.

The polyester resin containing an isocyanate group is not particularly limited and may be appropriately selected depending on the intended purpose. Examples of the polyester resin include, but are not limited to, a reaction product of a polyester resin having an active hydrogen group and a polyisocyanate. The polyester resin having an active hydrogen group is obtained, for example, by polycondensing a diol, a dicarboxylic acid, and at least one selected from the group consisting of an alcohol having a functionality of three or more and a carboxylic acid having a functionality of three or more. The alcohol having a functionality of three or more and the carboxylic acid having a functionality of three or more impart a branched structure to the polyester resin containing an isocyanate group.

The diol is not particularly limited and can be appropriately selected depending on the intended purpose. Examples of the diol include, but are not limited to: aliphatic diols such as ethylene glycol, 1,2-propylene glycol, 1,3-propylene glycol, 1,4-butanediol, 3-methyl-1,5-pentanediol, 1,6-hexanediol, 1,8-octanediol, 1,10-decanediol, and 1,12-dodecanediol; diols having an oxyalkylene group, such as diethylene glycol, triethylene glycol, dipropylene glycol, polyethylene glycol, polypropylene glycol, and polytetramethylene glycol; alicyclic diols such as 1,4-cyclohexanedimethanol and hydrogenated bisphenol A; those obtained by adding an alkylene oxides such as ethylene oxide, propylene oxide, and butylene oxide to alicyclic diols; bisphenols such as bisphenol A, bisphenol F, and bisphenol S; and alkylene oxide adducts of bisphenols, such as those obtained by adding an alkylene oxide such as ethylene oxide, propylene oxide, and butylene oxide to bisphenols. Among these, aliphatic diols having 4 to 12 carbon atoms are preferred.

These diols may be used alone or in combination of two or more.

The dicarboxylic acid is not particularly limited and can be appropriately selected depending on the intended purpose. Examples of the dicarboxylic acid include, but are not limited to, aliphatic dicarboxylic acids and aromatic dicarboxylic acids. Further, anhydrides of these, lower alkyl esters (having 1 to 3 carbon atoms), or halides of these may also be used.

The aliphatic dicarboxylic acid is not particularly limited and can be appropriately selected depending on the intended purpose. Examples of the aliphatic dicarboxylic acid include, but are not limited to, succinic acid, adipic acid, sebacic acid, dodecanedioic acid, maleic acid, and fumaric acid.

The aromatic dicarboxylic acid is not particularly limited and can be appropriately selected depending on the intended purpose; however, an aromatic dicarboxylic acid having 8 to 20 carbon atoms is preferred. The aromatic dicarboxylic acid having 8 to 20 carbon atoms is not particularly limited and can be appropriately selected depending on the intended purpose. Examples of the aromatic dicarboxylic acid include, but are not limited to, phthalic acid, isophthalic acid, terephthalic acid, and naphthalenedicarboxylic acid.

Among these, aliphatic dicarboxylic acids having 4 to 12 carbon atoms are preferred. These dicarboxylic acids may be used alone or in combination of two or more.

The alcohol having a functionality of three or more is not particularly limited and may be appropriately selected depending on the intended purpose. Examples of the alcohol include, but are not limited to, aliphatic alcohols having a functionality of three or more, polyphenols having a functionality of three or more, and alkylene oxide adducts of polyphenols having a functionality of three or more.

Examples of the aliphatic alcohol having a functionality of three or more include, but are not limited to, glycerin, trimethylolethane, trimethylolpropane, pentaerythritol, and sorbitol.

Examples of the polyphenols having a functionality of three or more include, but are not limited to, trisphenol PA, phenol novolac, and cresol novolac.

Examples of the alkylene oxide adducts of polyphenols having a functionality of three or more include, but are not limited to, those obtained by subjecting polyphenols having a functionality of three or more to an addition reaction with an alkylene oxide such as ethylene oxide, propylene oxide, or butylene oxide.

The amorphous polyester resin A preferably includes an aliphatic alcohol having a functionality of three or more as a constituent component.

Since the amorphous polyester resin A includes an aliphatic alcohol having a functionality of three or more as a constituent component, the amorphous polyester resin A has a branched structure in its molecular backbone, and molecular chains form a three-dimensional network structure. Therefore, the amorphous polyester resin A exhibits rubber-like properties such that it deforms at low temperature but does not flow. Therefore, it is possible to maintain the heat-resistant storage stability and high-temperature offset resistance of the toner.

The amorphous polyester resin A may also use, as a crosslinking component, a carboxylic acid having a functionality of three or more, an epoxy compound, or the like; however, when a carboxylic acid is used, the carboxylic acid is often an aromatic compound, and the ester bond density of the crosslinked portion increases. As a result, the gloss of a fixed image produced by heat-fixing the toner may not be sufficiently expressed. When a crosslinking agent such as epoxy is used, a crosslinking reaction must be performed after the polymerization of the polyester, making it difficult to control the distance between crosslinking points. As a result, the intended viscoelasticity may not be obtained, or portions having a high crosslinking density are likely to be formed by reaction with oligomers during polyester production, which may cause unevenness in the fixed image and result in reduced gloss or reduced image density.

The carboxylic acid having a functionality of three or more is not particularly limited and may be appropriately selected depending on the intended purpose. Examples of the carboxylic acid include, but are not limited to, aromatic carboxylic acids having a functionality of three or more. Further, anhydrides of these, lower alkyl esters (having 1 to 3 carbon atoms), or halides of these may also be used.

The aromatic carboxylic acid having a functionality of three or more preferably has an aromatic carboxylic acid having 9 to 20 carbon atoms and having a functionality of three or more. Examples of the aromatic carboxylic acids having a functionality of three or more and 9 to 20 carbon atoms include, but are not limited to, trimellitic acid and pyromellitic acid.

The polyisocyanate is not particularly limited and can be appropriately selected depending on the intended purpose. Examples of the polyisocyanate include, but are not limited to, diisocyanates and isocyanates having a functionality of three or more.

Examples of the diisocyanates include, but are not limited to, aliphatic diisocyanates, alicyclic diisocyanates, aromatic diisocyanates, aromatic aliphatic diisocyanates, isocyanurates, and those obtained by blocking these with a phenol derivative, an oxime, and caprolactam or the like.

The aliphatic diisocyanate is not particularly limited and can be appropriately selected depending on the intended purpose. Examples of the aliphatic diisocyanate include, but are not limited to, tetramethylene diisocyanate, hexamethylene diisocyanate, methyl 2,6-diisocyanatocaproate, octamethylene diisocyanate, decamethylene diisocyanate, dodecamethylene diisocyanate, tetradecamethylene diisocyanate, trimethylhexane diisocyanate, and tetramethylhexane diisocyanate.

The alicyclic diisocyanate is not particularly limited and can be appropriately selected depending on the intended purpose. Examples of the alicyclic diisocyanate include, but are not limited to, isophorone diisocyanate and cyclohexylmethane diisocyanate.

The aromatic diisocyanate is not particularly limited and can be appropriately selected depending on the intended purpose. Examples of the aromatic diisocyanate include, but are not limited to, tolylene diisocyanate, diisocyanatodiphenylmethane, 1,5-naphthylene diisocyanate, 4,4′-diisocyanatodiphenyl, 4,4′-diisocyanato-3,3′-dimethyldiphenyl, 4,4′-diisocyanato-3-methyldiphenylmethane, and 4,4′-diisocyanato-diphenyl ether.

The aromatic aliphatic diisocyanate is not particularly limited and can be appropriately selected depending on the intended purpose. Examples of the aromatic aliphatic diisocyanate include, but are not limited to, α,α,α′,α′,-tetramethylxylylene diisocyanate.

The isocyanurates are not particularly limited and can be appropriately selected depending on the intended purpose. Examples of the isocyanurates include, but are not limited to, tris(isocyanatoalkyl) isocyanurate and tris(isocyanatocycloalkyl) isocyanurate. These polyisocyanates may be used alone or in combination of two or more.

### —Curing Agent—

The curing agent is not particularly limited and can be appropriately selected depending on the intended purpose, as long as the curing agent can react with the non-linear reactive precursor to produce the amorphous polyester resin A. Examples of the curing agent include, but are not limited to, active hydrogen group-containing compounds.

### —Active Hydrogen Group-containing Compound—

The active hydrogen group in the active hydrogen group-containing compound is not particularly limited and can be appropriately selected depending on the intended purpose. Examples of the active hydrogen group include, but are not limited to, a hydroxyl group (an alcoholic hydroxyl group and a phenolic hydroxyl group), an amino group, a carboxyl group, and a mercapto group. These may be used alone or in combination of two or more.

The active hydrogen group-containing compound is not particularly limited and can be appropriately selected depending on the intended purpose; however, amines are preferred because a urea bond can be formed.

The amines are not particularly limited and can be appropriately selected depending on the intended purpose. Examples of the amines include, but are not limited to, diamines, amines having a functionality of three or more, amino alcohols, amino mercaptans, amino acids, and those obtained by blocking these amino groups. These may be used alone or in combination of two or more.

Among these, diamines and mixtures of a diamine with a small amount of an amine having a functionality of three or more are preferable.

The diamine is not particularly limited and can be appropriately selected depending on the intended purpose. Examples of the diamine include, but are not limited to, aromatic diamines, alicyclic diamines, and aliphatic diamines. The aromatic diamine is not particularly limited and can be appropriately selected depending on the intended purpose. Examples of the aromatic diamine include, but are not limited to, phenylenediamine, diethyltoluenediamine, and 4,4′-diaminodiphenylmethane. The alicyclic diamine is not particularly limited and can be appropriately selected depending on the intended purpose. Examples of the alicyclic diamine include, but are not limited to, 4,4′-diamino-3,3′-dimethyldicyclohexylmethane, diaminocyclohexane, and isophoronediamine. The aliphatic diamine is not particularly limited and can be appropriately selected depending on the intended purpose. Examples of the aliphatic diamine include, but are not limited to, ethylenediamine, tetramethylenediamine, and hexamethylenediamine.

The amine having a functionality of three or more is not particularly limited and can be appropriately selected depending on the intended purpose. Examples of the amine include, but are not limited to, diethylenetriamine and triethylenetetramine.

The amino alcohol is not particularly limited and can be appropriately selected depending on the intended purpose. Examples of the amino alcohol include, but are not limited to, ethanolamine and hydroxyethylaniline.

The amino mercaptan is not particularly limited and can be appropriately selected depending on the intended purpose. Examples of the amino mercaptan include, but are not limited to, aminoethyl mercaptan and aminopropyl mercaptan.

The amino acid is not particularly limited and can be appropriately selected depending on the intended purpose. Examples of the amino acid include, but are not limited to, aminopropionic acid and aminocaproic acid.

The compound in which the amino group is blocked is not particularly limited and can be appropriately selected depending on the intended purpose. Examples of such compounds include, but are not limited to, ketimine compounds and oxazoline compounds obtained by blocking the amino group with ketones such as acetone, methyl ethyl ketone, and methyl isobutyl ketone.

In order to lower the Tg of the amorphous polyester resin A and to facilitate imparting a property of deforming at low temperature, the amorphous polyester resin A preferably contains a diol component as a constituent component, and the diol component preferably contains not less than 50% by mass of an aliphatic diol having 4 to 12 carbon atoms.

Also, in order to lower the Tg of the amorphous polyester resin A and to facilitate imparting a property of deforming at low temperature, the amorphous polyester resin A preferably contains not less than 50% by mass of an aliphatic diol having 4 to 12 carbon atoms in all alcohol components.

In order to lower the Tg of the amorphous polyester resin A and to facilitate imparting a property of deforming at low temperature, the amorphous polyester resin A preferably contains a dicarboxylic acid component as a constituent component, and the dicarboxylic acid component preferably contains not less than 50% by mass of an aliphatic dicarboxylic acid having 4 to 12 carbon atoms.

The weight-average molecular weight of the amorphous polyester resin A is not particularly limited and can be appropriately selected depending on the intended purpose; however, the weight-average molecular weight is preferably not less than 20,000 and not more than 1,000,000, more preferably not less than 50,000 and not more than 300,000, and particularly preferably not less than 100,000 and not more than 200,000, as measured by Gel Permeation Chromatography (GPC). If the weight-average molecular weight is less than 20,000, the toner tends to flow at low temperature, which may result in poor heat-resistant storage stability. Further, the viscosity of the toner upon melting tends to decrease, which may result in reduced high-temperature offset resistance.

The molecular structure of the amorphous polyester resin A can be confirmed by NMR measurement in solution or in the solid state, as well as by X-ray diffraction, GC/MS, LC/MS, IR measurement, and the like. As a simple method, a resin that exhibits no absorption attributable to olefinic δ CH (out-of-plane bending vibration) at 965±10 cm⁻¹ and 990±10 cm⁻¹ in an infrared absorption spectrum can be detected as an amorphous polyester resin.

The content of the amorphous polyester resin A is not particularly limited and can be appropriately selected depending on the intended purpose; however, the content is preferably not less than 5 parts by mass and not more than 25 parts by mass, and more preferably not less than 10 parts by mass and not more than 20 parts by mass, based on 100 parts by mass of the toner. If the content is less than 5 parts by mass, low-temperature fixability and high-temperature offset resistance may deteriorate. If the content exceeds 25 parts by mass, heat-resistant storage stability may deteriorate, and the gloss of an image obtained after fixing may decrease. When the content is within the more preferred range, it is advantageous in that low-temperature fixability, high-temperature offset resistance, and heat-resistant storage stability are all excellent.

—Amorphous Polyester Resin B—The amorphous polyester resin B preferably has a glass transition temperature (Tg) of not less than 40 °C and not more than 80 °C.

As the amorphous polyester resin B, a linear polyester resin is preferred.

As the amorphous polyester resin B, an unmodified polyester resin is preferred. The unmodified polyester resin is a polyester resin obtained using a polyhydric alcohol and a polycarboxylic acid or a derivative of a polycarboxylic acid, such as a polycarboxylic acid anhydride or a polycarboxylic acid ester, and a polyester resin that is not modified with an isocyanate compound or the like.

The amorphous polyester resin B preferably has no urethane bond and no urea bond.

The amorphous polyester resin B preferably includes a dicarboxylic acid component as a constituent component, and the dicarboxylic acid component preferably contains not less than 50 mol % of terephthalic acid. This is advantageous in terms of a heat-resistant storage stability.

Examples of the polyhydric alcohol include, but are not limited to, diols.

Examples of the diol include, but are not limited to, alkylene oxide (having 2 to 3 carbon atoms; average number of moles added: 1 to 10) adducts of bisphenol A, such as polyoxypropylene (2.2)-2,2-bis(4-hydroxyphenyl) propane and polyoxyethylene (2.2)-2,2-bis(4-hydroxyphenyl) propane; ethylene glycol and propylene glycol; and hydrogenated bisphenol A and alkylene oxide (having 2 to 3 carbon atoms; average number of moles added: 1 to 10) adducts of hydrogenated bisphenol A.

These may be used alone or in combination of two or more.

Examples of the polycarboxylic acid include, but are not limited to, dicarboxylic acids.

Examples of the dicarboxylic acid include, but are not limited to, adipic acid, phthalic acid, isophthalic acid, terephthalic acid, fumaric acid, maleic acid; and succinic acid substituted with an alkyl group having 1 to 20 carbon atoms or an alkenyl group having 2 to 20 carbon atoms, such as dodecenylsuccinic acid and octylsuccinic acid. These may be used alone or in combination of two or more.

Further, for the purpose of adjusting the acid value and the hydroxyl value, the amorphous polyester resin B may contain, at a terminal of the resin chain, at least one selected from the group consisting of a carboxylic acid having a functionality of three or more and an alcohol having a functionality of three or more.

Examples of the carboxylic acid having a functionality of three or more include, but are not limited to, trimellitic acid, pyromellitic acid, and anhydrides of these acids.

Examples of the alcohol having a functionality of three or more include, but are not limited to, glycerin, pentaerythritol, and trimethylolpropane.

The molecular weight of the amorphous polyester resin B is not particularly limited and can be appropriately selected depending on the intended purpose. However, if the molecular weight is too low, the toner may exhibit poor heat-resistant storage stability of the toner and durability against stress, such as that caused by stirring in a developing unit. If the molecular weight is too high, the viscoelasticity of the toner upon melting increases and the low-temperature fixability may be poor. Therefore, the weight-average molecular weight (Mw) is preferably 3,000 to 10,000 as measured by Gel Permeation Chromatography (GPC). Further, the number-average molecular weight (Mn) is preferably 1,000 to 4,000. Further, Mw/Mn is preferably 1.0 to 4.0.

The weight-average molecular weight (Mw) is more preferably 4,000 to 7,000. The number-average molecular weight (Mn) is more preferably 1,500 to 3,000. The Mw/Mn is more preferably 1.0 to 3.5.

The acid value of the amorphous polyester resin B is not particularly limited and can be appropriately selected depending on the intended purpose, but is preferably not less than 1 mg KOH/g and not more than 50 mg KOH/g, and more preferably not less than 5 mg KOH/g and not more than 30 mg KOH/g. When the acid value is not less than 1 mg KOH/g, the toner tends to be negatively chargeable, and furthermore, the affinity between paper and the toner is improved during fixing to paper, thereby improving low-temperature fixability. When the acid value is not more than 50 mg KOH/g, charging stability, particularly charging stability against environmental fluctuations, becomes favorable.

The hydroxyl value of the amorphous polyester resin B is not particularly limited and can be appropriately selected depending on the intended purpose, but is preferably not less than 5 mg KOH/g.

The glass transition temperature (Tg) of the amorphous polyester resin B is preferably not less than 40 °C and not more than 80 °C, and more preferably not less than 50 °C and not more than 70 °C. When the glass transition temperature is not less than 40 °C, the toner exhibits sufficient heat-resistant storage stability and durability against stress, such as that caused by stirring in a developing unit, and also exhibits favorable filming resistance. When the glass transition temperature is not more than 80 °C, deformation of the toner due to application of heat and pressure during fixing is sufficient, thereby providing favorable low-temperature fixability.

The molecular structure of the amorphous polyester resin B can be confirmed by NMR measurement in solution or in the solid state, as well as by X-ray diffraction, GC/MS, LC/MS, IR measurement, and the like. As a simple method, a resin that exhibits no absorption attributable to olefinic δCH (out-of-plane bending vibration) at 965±10 cm⁻¹ and 990±10 cm⁻¹ in an infrared absorption spectrum can be detected as an amorphous polyester resin.

The content of the amorphous polyester resin B is not particularly limited and can be appropriately selected depending on the intended purpose, but is preferably not less than 50 parts by mass and not more than 90 parts by mass, and more preferably not less than 60 parts by mass and not more than 80 parts by mass, based on 100 parts by mass of the toner. If the content is less than 50 parts by mass, the dispersibility of the pigment and the release agent in the toner deteriorates, which may readily cause image fogging or image irregularity. If it exceeds 90 parts by mass, the contents of a crystalline polyester resin C and the amorphous polyester resin A decrease, which may result in poor low-temperature fixability. When the content is within the more preferable range, it is advantageous in that high image quality and low-temperature fixability are both excellent.

### <Release Agent>

The release agent is not particularly limited and can be appropriately selected depending on the intended purpose. Examples of waxes include, but are not limited to, natural waxes, such as plant-based waxes including carnauba wax, cotton wax, haze wax, and rice wax; animal-based waxes including beeswax and lanolin; mineral-based waxes including ozokerite and ceresin; and petroleum waxes including paraffin wax, microcrystalline wax, and petrolatum.

In addition to these natural waxes, synthetic hydrocarbon waxes such as Fischer-Tropsch wax, polyethylene wax, and polypropylene wax; and synthetic waxes such as ester, ketone, and ether waxes can also be used.

Furthermore, the following materials can also be used: fatty acid amide compounds such as 12-hydroxystearic acid amide, stearic acid amide, phthalimide, and chlorinated hydrocarbons; homopolymers or copolymers of polyacrylates which are low-molecular-weight crystalline polymer resins, such as poly-n-stearyl methacrylate and poly-n-lauryl methacrylate (e.g., n-stearyl acrylate and ethyl methacrylate copolymer); crystalline polymers having a long alkyl group in a side chain; and the like.

Among these, hydrocarbon-based waxes such as paraffin wax, microcrystalline wax, Fischer-Tropsch wax, polyethylene wax, and polypropylene wax are preferred from the viewpoint that filming can be suppressed.

The melting point of the release agent is not particularly limited and can be appropriately selected depending on the intended purpose; however, the melting point is preferably not less than 60 °C and not more than 80 °C.

It is preferable that the melting point of the release agent is not less than 60 °C because this allows heat-resistant storage stability to become favorable.

It is preferable that the melting point of the release agent is not more than 80 °C because a high-quality image can be obtained.

The content of the release agent is not particularly limited and can be appropriately selected depending on the intended purpose, but is preferably not less than 2 parts by mass and not more than 10 parts by mass, and more preferably not less than 3 parts by mass and not more than 8 parts by mass, based on 100 parts by mass of the toner.

### <Wax Dispersant>

Since the toner according to an embodiment of the present invention contains a wax dispersant, dispersibility of the wax is improved, thereby suppressing the amount of wax exposed. Thereby, the amount of wax can be increased without deteriorating the heat-resistant storage stability, and the low-temperature fixability can be improved.

The wax dispersant in the toner according to an embodiment of the present invention includes a styrene resin. By including a styrene resin, the heat-resistant storage stability of the toner is improved.

Examples of the styrene resin include, but are not limited to, styrene-based resins (homopolymers or copolymers containing styrene or a substituted styrene) such as polystyrene, poly-α-methylstyrene, styrene-chlorostyrene copolymer, styrene-propylene copolymer, styrene-butadiene copolymer, styrene-vinyl chloride copolymer, styrene-vinyl acetate copolymer, styrene-maleic acid copolymer, styrene-acrylate copolymer, styrene-methacrylate copolymer, styrene-methyl α-chloroacrylate copolymer, and styrene-acrylonitrile-acrylate copolymer.

Among these, preferred are an ethylene-propylene copolymer adduct of a styrene-2-ethylhexyl acrylate-maleic anhydride copolymer, a copolymer composition containing butyl acrylate and acrylonitrile, and a polyethylene adduct of the copolymer composition.

The glass transition temperature of the styrene resin is preferably not less than 50 °C, and more preferably not less than 60 °C. Also, it is preferably not more than 80 °C.

Compared to the polyester resin, which is the binder resin of the toner according to an embodiment of the present invention, styrene-based resins have higher compatibility with general waxes, thus the wax tends to be more finely dispersed. Further, styrene-based resins have a low internal cohesive force and exhibit excellent pulverizability compared to the polyester resin. Consequently, by using a styrene-based resin, even when the wax dispersion state is comparable, the interface between the wax and the resin is less likely to become a pulverized surface unlike with a polyester resins. This suppresses the exposure of wax on the toner particle surfaces, thereby improving the storage stability of the toner.

The content of the wax dispersant is preferably not more than 2 parts by mass, based on 100 parts by mass of the toner. By containing the wax dispersant, a dispersion effect of the wax is obtained, and improvement in storage stability can be stably expected regardless of the production method. Further, due to the dispersion effect of the wax, the wax diameter decreases, thereby making it possible to suppress a filming phenomenon on a photoconductor or the like. When the content is not more than 2 parts by mass, the amount of incompatible components with the polyester resin does not increase excessively, and gloss does not decrease. Further, the dispersibility of the wax does not become excessively high, the wax readily exudes to the surface of the toner during fixing, thereby improving low-temperature fixability and hot offset resistance.

### <Charge Control Agent>

The toner according to an embodiment of the present invention may be positively chargeable or negatively chargeable. The chargeability can be controlled by a charge control agent.

The charge control agent is not particularly limited and can be appropriately selected depending on the intended purpose. Examples of the charge control agent include, but are not limited to, nigrosine dyes, triphenylmethane dyes, chromium-containing metal complex dyes, molybdic acid chelate pigments, rhodamine dyes, alkoxy amines, quaternary ammonium salts (including fluorine-modified quaternary ammonium salts), alkylamides, elemental phosphorus or phosphorus compounds, elemental tungsten or tungsten compounds, fluorine-based surfactants, metal salts of salicylic acid, metal salts of salicylic acid derivatives, metal salts of hydroxynaphthoic acid, phenolic condensates, azo pigments, boron complexes, or polymer compounds having a functional group (e.g., a sulfonic acid group, a carboxyl group, or a quaternary ammonium salt). These may be used alone or in combination of two or more.

Specific examples of the charge control agent include, but are not limited to: nigrosine dye BONTRON 03, quaternary ammonium salt BONTRON P-51, metal-containing azo dye BONTRON S-34, hydroxynaphthoic acid-based metal complex E-82, salicylic acid-based metal complex E-84, and phenolic condensate E-89 (manufactured by Orient Chemical Industries Co., Ltd.); quaternary ammonium salt molybdenum complexes TP-302 and TP-415 (manufactured by Hodogaya Chemical Co., Ltd.); quaternary ammonium salt Copy Charge PSY VP2038, triphenylmethane derivative Copy Blue PR, quaternary ammonium salt Copy Charge NEG VP2036, and quaternary ammonium salt Copy Charge NX VP434 (manufactured by Hoechst); LRA-901 and boron complex LR-147 (manufactured by Japan Carlit Co., Ltd.); and copper phthalocyanine, perylene, quinacridone, and azo pigments.

The content of the charge control agent is not particularly limited and can be appropriately selected depending on the intended purpose, as long as it is used in an amount that allows the charge control agent to exhibit its performance and does not inhibit fixability or the like. The content is preferably 0.5% by mass to 5% by mass, and more preferably 0.8% by mass to 3% by mass, based on the total mass of the resin fine particles.

The charge control agent may be premixed with the resin, wax, and pigment and melt-kneaded when producing the toner base, or may be made into a masterbatch and kneaded and dispersed, and is not particularly limited.

### <Colorant>

The colorant is not particularly limited and can be appropriately selected depending on the intended purpose. Examples of the colorant include, but are not limited to, carbon black, nigrosine dye, iron black, naphthol yellow S, Hansa yellow (10G, 5G, G), cadmium yellow, yellow iron oxide, loess, chrome yellow, titanium yellow, polyazo yellow, oil yellow, Hansa yellow (GR, A, RN, R), pigment yellow L, benzidine yellow (G, GR), permanent yellow (NCG), vulcan fast yellow (5G, R), tartrazine lake, quinoline yellow lake, anthrazane yellow BGL, isoindolinone yellow, red iron oxide, red lead, lead vermilion, cadmium red, cadmium mercury red, antimony vermilion, permanent red 4R, para red, fire red, parachloro-orthonitroaniline red, lithol fast scarlet G, brilliant fast scarlet, brilliant carmine BS, permanent red (F2R, F4R, FRL, FRLL, F4RH), fast scarlet VD, vulcan fast rubine B, brilliant scarlet G, lithol rubine GX, permanent red F5R, brilliant carmine 6B, pigment scarlet 3B, bordeaux 5B, toluidine maroon, permanent bordeaux F2K, helio bordeaux BL, bordeaux 10B, bon maroon light, bon maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, victoria blue lake, metal-free phthalocyanine blue, phthalocyanine blue, fast sky blue, indanthrene blue (RS, BC), indigo, ultramarine blue, prussian blue, anthraquinone blue, fast violet B, methyl violet lake, cobalt violet, manganese violet, dioxane violet, anthraquinone violet, chrome green, zinc green, chromium oxide, viridian, emerald green, pigment green B, naphthol green B, green gold, acid green lake, malachite green lake, phthalocyanine green, anthraquinone green, titanium oxide, zinc white, and lithopone. These may be used alone or in combination of two or more.

The colorant can be used in both black toners and full-color toners.

The content of the colorant is not particularly limited and can be appropriately selected depending on the intended purpose; however, the content is preferably not less than 1 part by mass and not more than 35 parts by mass, and more preferably not less than 3 parts by mass and not more than 20 parts by mass, based on 100 parts by mass of the toner.

### <External Additive>

Examples of the external additive include, but are not limited to, abrasives such as silica, Teflon (registered trademark) resin powder, polyvinylidene fluoride powder, cerium oxide powder, silicon carbide powder, and strontium titanate powder; fluidity improvers and anti-caking agents such as titanium oxide powder and aluminum oxide powder; and conductivity imparting agents such as zinc oxide powder, antimony oxide powder, and tin oxide powder. Further, white fine particles and black fine particles each having an opposite polarity can also be used as a developability-improving agent. These may be used alone or in combination of two or more, and are selected so as to provide resistance against development stress, such as idling.

### <Toner Properties>

The amount of wax and the amount of wax dispersant near the toner particle surface are obtained by Fourier transform infrared spectroscopy with attenuated total reflectance (FTIR-ATR). Based on the measurement principle, the analysis depth is about 0.3 μm. This analysis enables determination of the relative amounts of wax and wax dispersant in a region extending to a depth of about 0.3 μm from the surface of a toner particle. The measurement method is as follows.

First, as a sample, 3 g of toner was pressed at a load of 6 tonnes for 1 minute using an automatic pellet molding machine (Type M No. 50 BRP-E; manufactured by MAEKAWA TESTING MACHINE CO.) to prepare a pellet 40 mm in diameter (thickness: about 2 mm). The surface of the obtained pellet was measured by FTIR-ATR.

The micro-FTIR apparatus used was a Spectrum One manufactured by PerkinElmer and equipped with a MultiScope FTIR unit, and measurement was performed using a micro-ATR with a germanium (Ge) crystal having a diameter of 100 μm. Measurement was performed at an infrared incident angle of 41.5°, a resolution of 4 cm⁻¹, and an accumulation of 20 scans.

The maximum peak height W (wax-derived peak) of the spectrum in a range of 2834 to 2862 cm⁻¹ and the maximum peak height R1 (binder resin-derived peak) of the spectrum in a range of 743 to 890 cm⁻¹ were determined, and the ratio (W/R1) was defined as the relative amount of wax near the toner particle surface. Further, the maximum peak height R2 (wax dispersant-derived peak) of the spectrum in a range of 685 to 711 cm⁻¹ was determined, and the ratio (R2/R1) was defined as the relative amount of wax dispersant near the toner particle surface. The values used were the average of four measurements taken at different locations.

Regarding the amount of wax on the toner surface, the ratio (W/R1) is preferably not less than 0.035 and not more than 0.065. If the ratio (W/R1) is larger than 0.065, heat-resistant storage stability and stress resistance decrease. If the ratio (W/R1) is less than 0.035, the amount of wax near the surface is insufficient, failing to provide adequate releasability and resulting in image defects caused by offset.

Regarding the amount of wax dispersant on the toner surface, the ratio (R2/R1) is preferably not less than 0.075 and not more than 0.095.

### <Measurement of Weight- and Number-Average Particle Diameters of Toner>

The weight-average particle diameter and number-average particle diameter of the toner were performed using a particle size analyzer (“Multisizer III”, manufactured by Beckman Coulter, Inc.) with an aperture diameter of 100 μm, and the results were analyzed using analysis software (Beckman Coulter Multisizer 3 Version 3.51).

Further, the weight-average particle diameter of the toner is preferably 4.0 to 8.0 μm, and more preferably 5.0 to 6.5 μm. Furthermore, the ratio of weight-average particle diameter to the number-average particle diameter is preferably not more than 1.35, and more preferably not more than 1.25.

### [Method for Producing Toner]

As the method for producing the toner according to an embodiment of the present invention, the toner can be produced by a known production method including: a melt-kneading step of kneading toner materials while melting them to obtain a kneaded material; a pulverizing step of pulverizing the kneaded material to obtain a pulverized product; a classifying step of classifying the pulverized product to obtain toner base particles; and an external addition step of externally adding an external additive to the toner base particles.

In the melt-kneading step, the toner materials are mixed, and the resulting mixture is charged into a melt-kneader and melt-kneaded. As the melt-kneader, for example, a single-screw or twin-screw continuous kneader or a batch-type kneader using a roll mill can be used, and examples that can be suitably used include, but are not limited to: a KTK-type twin-screw extruder manufactured by Kobe Steel, Ltd.; a TEM-type extruder manufactured by Toshiba Machine Co., Ltd.; a twin-screw extruder manufactured by KCK Co., Ltd.; a PCM-type twin-screw extruder manufactured by Ikegai Corp.; and a Co-kneader manufactured by Buss.

The melt-kneading is preferably performed under appropriate conditions such that the molecular chains of the binder resin do not undergo scission. Specifically, the melt-kneading temperature is preferably set with reference to the softening point of the binder resin. If the temperature is excessively higher than the softening point, significant scission occurs, while if it is too low, dispersion may not sufficiently proceed.

In the pulverizing step, the kneaded material obtained in the melt-kneading step is pulverized. In this pulverization, it is preferable to first perform coarse pulverization of the kneaded material and then perform fine pulverization. Suitable examples of the pulverizing method include, but are not limited to: a method of pulverizing by causing collision against a collision plate in a jet stream; a method of pulverizing by causing collision between particles in a jet stream; and a method of pulverizing in a narrow gap between a mechanically rotating rotor and a stator.

In the classifying step, the pulverized product obtained in the pulverizing step is classified to obtain particles adjusted to a predetermined particle size. Examples of the classifying method include, but are not limited to, a method of removing fine particles using a cyclone, a decanter, a centrifugal separator, or the like. After the pulverizing step and the classifying step are completed, the pulverized product can be classified in an air stream by centrifugal force or the like to produce toner base particles having a predetermined particle size.

In the external addition step, an external additive is externally added to the toner base particles obtained in the classifying step. By mixing and stirring the toner base particles and the external additive using a mixer, the external additive is coated onto the surface of the toner base particles while being deagglomerated.

The external additive can be adhered to the toner base particles by mixing and stirring and applying mechanical impact force.

Examples of methods for applying mechanical impact force include, but are not limited to: a method of applying impact force to particles using an impeller rotating at high speed; and a method of introducing particles into a high-speed air stream and accelerating them so that the particles collide with each other or the composite particles collide with a suitable collision plate to apply impact force.

Examples of devices for applying mechanical impact force include, but are not limited to: an Ong Mill (manufactured by Hosokawa Micron Corporation); a device obtained by modifying an I-type mill (manufactured by Nippon Pneumatic Mfg. Co., Ltd.) to reduce pulverizing air pressure; a Hybridization System (manufactured by Nara Machinery Co., Ltd.); a Kryptron System (manufactured by Kawasaki Heavy Industries, Ltd.); and an automatic mortar.

### (Developer)

The developer according to an embodiment of the present invention includes the toner according to an embodiment of the present invention and, as necessary, other components appropriately selected, such as a carrier.

When the toner according to an embodiment of the present invention is used as a developer, the toner may be used as a one-component developer consisting of the toner alone, or may be mixed with a carrier and used as a two-component developer, and the developer is not particularly limited. The one-component developer is preferred because the advantages of the toner according to an embodiment of the present invention, namely, high stress resistance, excellent low-temperature fixability, and the ability to form high-quality images over a long period of time, can be obtained even under severe conditions in which stress is likely to be applied to the one-component developer in an image forming apparatus. On the other hand, the two-component developer is preferred from the viewpoint of improving service life and the like, when the toner is used in a high-speed printer compatible with recent increases in information processing speed.

When the developer is a two-component developer containing the toner according to an embodiment of the present invention and a carrier, the carrier may be a magnetic carrier or a non-magnetic carrier depending on the two-component development system.

Examples of the magnetic carrier include, but are not limited to: spinel ferrites such as magnetite and gamma iron oxide; spinel ferrites containing one or more metals other than iron (e.g., Mn, Ni, Zn, Mg, and Cu); magnetoplumbite-type ferrites such as barium ferrite; and iron or alloy particles having an oxide layer on the surface. The shape of the magnetic carrier may be any of granular, spherical, and acicular. Among these, particularly when high magnetization is required, it is preferable to use ferromagnetic fine particles such as iron, and from the viewpoint of chemical stability, spinel ferrites including magnetite and gamma iron oxide, and magnetoplumbite-type ferrites such as barium ferrite are preferred.

Specifically, suitable examples of the magnetoplumbite-type ferrite include, but are not limited to, MFL-35S and MFL-35HS (manufactured by Powdertech Co., Ltd.); and DFC-400M, DFC-410M, and SM-350NV (manufactured by DOWA IP CREATION Co., Ltd.).

As the magnetic carrier, it is also possible to use a resin carrier containing magnetic fine particles such as ferromagnetic fine particles, the type and content of which may be selected to provide a desired magnetization.

As for the magnetic property of the resin carrier, the magnetization at 1,000 Oersteds is preferably 30 emu/g to 150 emu/g.

Examples of methods for producing the resin carrier include, but are not limited to: a method for producing a resin carrier by spraying a melt-kneaded material of magnetic fine particles and an insulating binder resin with a spray dryer; a method for producing a resin carrier in which magnetic fine particles are dispersed in a condensation-type binder resin, by reacting and curing a monomer or prepolymer in an aqueous medium in the presence of magnetic fine particles; and a method for producing a resin carrier by fixing positively or negatively chargeable fine particles or conductive fine particles onto the surface of a magnetic carrier, coating the surface of the magnetic carrier with a resin, or coating the surface of the magnetic carrier with a resin containing positively or negatively chargeable fine particles or conductive fine particles. By these methods, chargeability can be appropriately controlled.

Examples of the resin for coating include, but are not limited to, silicone resins, acrylic resins, epoxy resins, and fluorine-based resins. Among these, silicone resins and acrylic resins are preferable.

The content of the carrier in the two-component developer is preferably not less than 85% by mass and less than 98% by mass. When the content is not less than 85% by mass, the occurrence of defective images caused by toner scattering from the developing device can be suppressed. When the content is less than 98% by mass, an excessive increase in the charge amount of the electrophotographic developing toner and an insufficient supply amount of the electrophotographic developing toner can be suppressed, thereby effectively preventing a decrease in image density and the occurrence of defective images.

### (Toner Container Unit)

The toner container unit according to an embodiment of the present invention refers to a unit having a function of storing toner, in which the toner according to an embodiment of the present invention is stored. Here, the toner container unit may take various forms, such as a toner storage container, a developing unit, and a process cartridge.

The toner storage container refers to a container in which the toner is stored.

The developing unit refers to a unit including a device for containing the toner to be used for development.”

The process cartridge refers to a cartridge in which at least an image bearer and a developing device are integrated, which stores the toner, and which is detachable from an image forming apparatus. The process cartridge may further include at least one selected from the group consisting of a charging device, an exposure device, and a cleaning device.

The toner according to an embodiment of the present invention is stored in the toner container unit according to an embodiment of the present invention. By mounting the toner container unit according to an embodiment of the present invention into an image forming apparatus for image formation, image formation is performed using the toner according to an embodiment of the present invention, which is resistant to stress and excellent in low-temperature fixability. Therefore, high-quality images can be formed over a long period of time.

### (Image Forming Apparatus and Image Forming Method)

The image forming apparatus according to an embodiment of the present invention includes at least an electrostatic latent image bearer, an electrostatic latent image forming device, a developing device, a transfer device, and a fixing device, and further includes other devices appropriately selected as necessary, such as a discharging device, a cleaning device, a recycling device, and a control device.

The image forming method according to an embodiment of the present invention includes at least an electrostatic latent image forming step, a developing step, a transfer step, and a fixing step, and further includes other steps appropriately selected as necessary, such as a discharging step, a cleaning step, a recycling step, and a control step.

The image forming method according to an embodiment of the present invention can be suitably implemented by the image forming apparatus according to an embodiment of the present invention; the electrostatic latent image forming step can be performed by the electrostatic latent image forming device, the developing step can be performed by the developing device, the transfer step can be performed by the transfer device, the fixing step can be performed by the fixing device, and the other steps can be performed by the other devices.

### <Electrostatic Latent Image Forming Step and Electrostatic Latent Image Forming Device>

The electrostatic latent image forming step is a step of forming an electrostatic latent image on the electrostatic latent image bearer.

The electrostatic latent image forming device is a device for forming an electrostatic latent image on the electrostatic latent image bearer.

The electrostatic latent image bearer (also referred to as “photoconductive insulator,” “electrophotographic photoconductor,” or “photoconductor”) is not particularly limited in terms of material, shape, structure, size, and the like, and can be appropriately selected from known ones. The shape is suitably a drum shape. Examples of the material include, but are not limited to, inorganic photoconductors such as amorphous silicon and selenium, and organic photoconductors such as polysilane and phthalopolymethine.

Examples of the organic photoconductor include, but are not limited to: a multi-layer photoconductor having a layered structure in which a layer (charge generation layer), in which a charge generation material, such as metal-free phthalocyanine or titanyl phthalocyanine, is dispersed in a binder resin, and a layer (charge transport layer), in which a charge transport material is dispersed in a binder resin, are stacked on a supporting member such as an aluminum drum; and a single-layer photoconductor having a photosensitive layer with a single-layer structure, in which both a charge generation material and a charge transport material are dispersed in a binder resin on a supporting member. In the single-layer photoconductor, a hole transport agent and an electron transport agent may also be added to the photosensitive layer as charge transport materials.

Further, an undercoat layer may be provided between the supporting member and the charge generation layer in the multi-layer photoconductor or between the supporting member and the photosensitive layer in the single-layer photoconductor.

The electrostatic latent image can be formed, for example, by uniformly charging the surface of the electrostatic latent image bearer and then exposing the surface imagewise, and this formation can be performed by the electrostatic latent image forming device.

The electrostatic latent image forming device includes, for example, at least a charging unit for uniformly charging the surface of the electrostatic latent image bearer and an exposure unit for exposing the surface of the electrostatic latent image bearer imagewise.

The charging can be performed, for example, by using the charging unit to apply a voltage to the surface of the electrostatic latent image bearer.

The charging unit is not particularly limited and can be appropriately selected depending on the intended purpose. Examples of the charging unit include, but are not limited to, a known contact charging unit equipped with a conductive or semi-conductive roller, brush, film, rubber blade, or the like, and a non-contact charging unit utilizing corona discharge such as a corotron or a scorotron.

The charging unit is preferably arranged in a contact or non-contact state with respect to the electrostatic latent image bearer, and charges the surface of the electrostatic latent image bearer by applying a DC voltage and an AC voltage superimposed on each other. Further, the charging unit is preferably a charging roller arranged in close proximity to the photoconductor in a non-contact manner, with a gap tape interposed between the charging roller and the photoconductor, and charges the surface of the photoconductor by applying a DC voltage and an AC voltage superimposed on each other to the charging roller.

The exposure can be performed, for example, by using the exposure unit to expose the surface of the electrostatic latent image bearer imagewise.

The exposure unit is not particularly limited as long as it can expose, imagewise, the surface of the photoconductor charged by the charging unit, and can be appropriately selected depending on the intended purpose. Examples of the exposure device include, but are not limited to, a copying optical system, a rod lens array system, a laser optical system, and a liquid crystal shutter optical system. Note that a backside exposure system, in which imagewise exposure is performed from the back side of the photoconductor, may also be adopted.

### <Developing Step and Developing Device>

The developing step is a step of developing the electrostatic latent image using the toner or the developer according to an embodiment of the present invention to form a visible image.

The developing device is a device for developing the electrostatic latent image using the toner or the developer according to an embodiment of the present invention to form a visible image.

The visible image can be formed, for example, by developing the electrostatic latent image using the toner or the developer according to an embodiment of the present invention, and this formation can be performed by the developing device.

The developing device is not particularly limited as long as it can perform development using the toner or developer according to an embodiment of the present invention, and can be appropriately selected from among known developing devices. Suitable examples of the developing device include, but are not limited to, one having at least a developing unit that accommodates the toner or developer according to an embodiment of the present invention and can apply the toner or developer to the electrostatic latent image in a contact or non-contact manner. More preferably, the developing device includes a developing unit equipped with the toner-containing container according to an embodiment of the present invention in a detachable manner.

The developing unit may be of a dry development system or a wet development system, and may be a single-color developing unit or a multi-color developing unit. Suitable examples of the developing unit include, but are not limited to, a unit including a stirrer for charging the toner or the developer by friction stirring and a rotatable magnet roller is suitably mentioned.

In the developing unit, for example, the toner and the carrier are mixed and stirred, the toner is charged by friction during the mixing and stirring, and is held on the surface of the rotating magnet roller in a brush-like state, thereby forming a magnetic brush. Since the magnet roller is arranged near the electrostatic latent image bearer, a portion of the toner constituting the magnetic brush formed on the surface of the magnet roller moves to the surface of the electrostatic latent image bearer due to electrostatic attraction. As a result, the electrostatic latent image is developed by the toner, and a visible image is formed by the toner on the surface of the electrostatic latent image bearer. Note that when moving the toner to the surface of the electrostatic latent image bearer, it is preferable to apply an alternating electric field.

### <Transfer Step and Transfer Device>

The transfer step is a step of transferring the visible image to a recording medium.

The transfer device is a device for transferring the visible image to a recording medium.

A preferred aspect of the transfer step uses an intermediate transferor, in which the visible image is primarily transferred to the intermediate transferor and then secondarily transferred to the recording medium. A more preferred aspect of the transfer step includes a primary transfer step that forms a composite transfer image by transferring visible images, using two or more toner colors (preferably full-color toners), onto the intermediate transferor, and a secondary transfer step that transfers the composite transfer image onto the recording medium.

The transfer of the visible image can be performed, for example, by charging the electrostatic latent image bearer using a transfer charging unit, and can be performed by the transfer device. A preferred aspect of the transfer device includes a primary transfer device for forming a composite transfer image by transferring visible images onto an intermediate transferor, and a secondary transfer device for transferring the composite transfer image onto a recording medium.

The transfer device (the primary transfer device and the secondary transfer device) preferably includes at least a transfer unit that charges and separates the visible image formed on the electrostatic latent image bearer toward a transfer-receiving member. The transfer device may be one or may be two or more. Examples of the transfer unit include, but are not limited to, a corona transfer unit using corona discharger, a transfer belt, a transfer roller, a pressure transfer roller, and an adhesive transfer unit.

The intermediate transferor is not particularly limited and can be appropriately selected from among known transferors depending on the intended purpose. Suitable examples of the intermediate transferor include, but are not limited to, a transfer belt.

The transfer-receiving member is not particularly limited and can be appropriately selected from among known recording media (recording paper).

### <Fixing Step and Fixing Device>

The fixing step is a step of fixing the visible image transferred to the recording medium.

The fixing device is a device for fixing the visible image transferred to the recording medium.

The fixing step may be performed for each toner color each time it is transferred to the recording medium, or may be performed at once with the toners of the respective colors in a superposed state.

The fixing device is not particularly limited and can be appropriately selected depending on the intended purpose, but known heating and pressing device are suitable. Examples of the fixing device include, but are not limited to: a combination of a heating roller and a pressure roller; a combination of a heating roller, a pressure roller, and an endless belt; and a unit having a heating member provided with a heat generator, a film in contact with the heating member, and a pressing member in pressure contact with the heating member via the film, in which a transfer-receiving member bearing an unfixed image is passed between the film and the pressing member to perform heat-and-pressure fixing.

The heating temperature in the fixing device is usually preferably 80 °C to 200 °C.

In the present disclosure, a known optical fixing unit may be used, for example, together with or instead of the fixing step and fixing device, depending on the intended purpose.

### Other Steps and Other Means

The discharging step is a step of applying a discharge bias to the electrostatic latent image bearer to perform discharging, and can be suitably performed by the discharging device.

The discharging device is not particularly limited, as long as it can apply a discharge bias to the electrostatic latent image bearer. The discharging device can be appropriately selected from among known discharging units, and suitable examples of the discharging device include, but are not limited to, a discharge lamp.

The cleaning step is a step of removing the toner remaining on the electrostatic latent image bearer, and can be suitably performed by the cleaning device.

The cleaning device is not particularly limited, as long as it can remove the toner remaining on the electrostatic latent image bearer. The cleaning device can be appropriately selected from known cleaners, and suitable examples include a magnetic brush cleaner, an electrostatic brush cleaner, a magnetic roller cleaner, a blade cleaner, a brush cleaner, and a web cleaner.

The recycling step is a step of recycling the toner removed in the cleaning step back to the developing device, and this step can be suitably performed by the recycling device.

The recycling device is not particularly limited, and examples include, but are not limited to, known conveyance devices.

The control step is a step of controlling each of the steps and can be suitably performed by the control device.

The control device is not particularly limited as long as it can control the operation of each of the above devices, and can be appropriately selected depending on the intended purpose. Examples of the control device include, but are not limited to, equipment such as a sequencer and a computer.

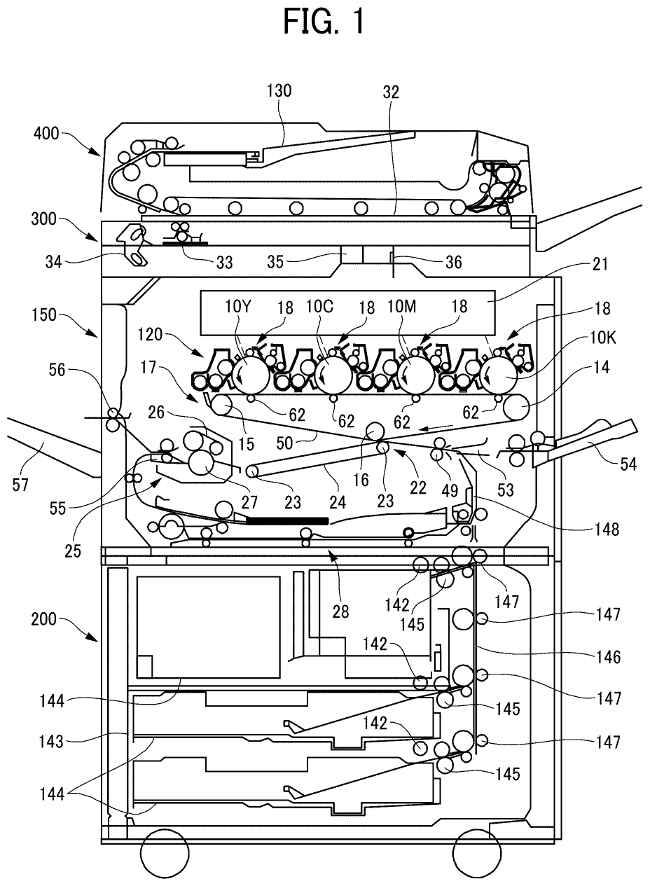

Next, another aspect of the image forming method according to an embodiment of the present invention will be described with reference to FIG. 1.

An image forming apparatus illustrated in FIG. 1 is a tandem-type color image forming apparatus. This image forming apparatus is equipped with a copying apparatus main body 150, a paper feeding table 200, a scanner 300, and an automatic document feeder (ADF) 400.

In the copying apparatus main body 150, an endless-belt-shaped intermediate transferor 50 is provided in a central portion.

The intermediate transferor 50 is stretched over support rollers 14, 15, and 16, and is rotatable clockwise in FIG. 1. In the vicinity of the support roller 15, an intermediate transferor cleaning unit 17 for removing residual toner from the intermediate transferor 50 is arranged. On the intermediate transferor 50 stretched between the support roller 14 and the support roller 15, an image forming device 120 is arranged, in which four image forming units 18 for yellow, cyan, magenta, and black are arranged along the conveying direction in parallel and face the intermediate transferor 50. In the vicinity of the image forming device 120, an exposure device 21 is arranged. On the opposite side of the intermediate transferor 50 from the side on which the image forming device 120 is arranged, a secondary transfer unit 22 is arranged. In the secondary transfer unit 22, an endless secondary transfer belt 24 is stretched over a pair of rollers 23, and the transfer paper conveyed on the secondary transfer belt 24 and the intermediate transferor 50 can be brought into contact with each other. A fixing device 25 is arranged in the vicinity of the secondary transfer unit 22. The fixing device 25 is equipped with an endless fixing belt 26 and a pressure roller 27 arranged to be pressed against the belt.

Note that in the tandem image forming apparatus, a sheet inverting device 28 for inverting the transfer paper to perform image formation on both sides of the transfer paper is arranged in the vicinity of the secondary transfer unit 22 and the fixing device 25.

Next, the formation of a full-color image (color copying) using the image forming device 120 will be described. That is, first, either an original is set on an original table 130 of the automatic document feeder (ADF) 400, or the automatic document feeder 400 is opened, an original is set on a contact glass 32 of the scanner 300, and the automatic document feeder 400 is closed.

When a start switch is pressed, the scanner 300 is driven and a first traveling member 33 and a second traveling member 34 begin to travel. This occurs immediately when an original is set on the contact glass 32, or after the original is conveyed and moved onto the contact glass 32 when the original is set in the automatic document feeder 400. At this time, light from a light source is emitted by the first traveling member 33 onto the document, and the reflected light from the surface of the document is reflected by a mirror in the second traveling member 34. The reflected light is then received by a reading sensor 36 through an image forming lens 35 to read the color document (color image) as image information of black, yellow, magenta, and cyan. Next, each piece of image information is transmitted to the respective image forming units 18 in the image forming device 120, whereby visible images of black, yellow, magenta, and cyan are formed.

Then, each piece of image information for black, yellow, magenta, and cyan is transmitted to the respective image forming units 18 (an image forming unit for black, an image forming unit for yellow, an image forming unit for magenta, and an image forming unit for cyan) of the tandem-type image forming device 120, and toner images of black, yellow, magenta, and cyan are formed in the respective image forming units 18.

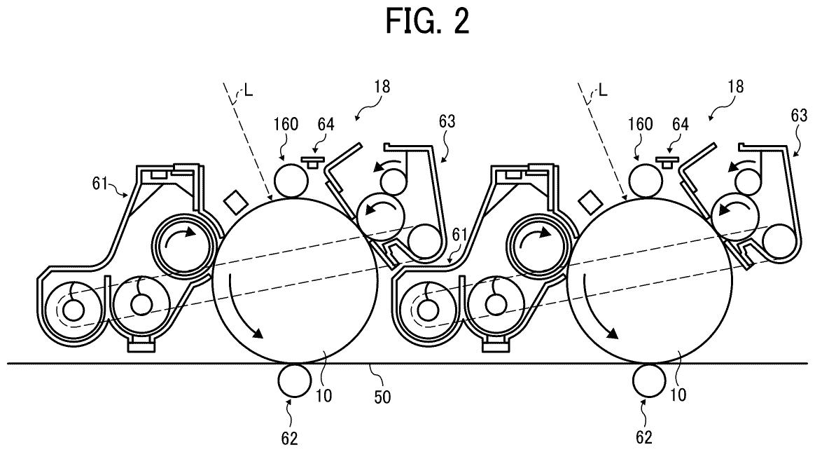

That is, each color image forming unit 18 (an image forming unit for black, an image forming unit for yellow, an image forming unit for magenta, and an image forming unit for cyan) of the image forming device 120, as illustrated in FIG. 2, includes an electrostatic latent image bearer 10, a charging device 160 for uniformly charging the electrostatic latent image bearer 10, a developing device 61 that develops the electrostatic latent image using each color toner (black toner, yellow toner, magenta toner, and cyan toner) to form a toner image of each color toner, a transfer charging unit 62 for transferring the toner image onto the intermediate transferor 50, a cleaning unit 63, and a discharging unit 64. The electrostatic latent image bearer 10 is exposed to exposure light (L in FIG. 2) from the exposure device 21 in accordance with the respective color image information to form an electrostatic latent image corresponding to each color image on the electrostatic latent image bearer 10 to form a single-color image (a black image, a yellow image, a magenta image, and a cyan image) based on the respective color image information. The black image, yellow image, magenta image, and cyan image thus formed are sequentially transferred (primary transfer) onto the intermediate transferor 50 rotated by the support rollers 14, 15, and 16, by transferring the black image formed on a black electrostatic latent image bearer 10K, the yellow image formed on a yellow electrostatic latent image bearer 10Y, the magenta image formed on a magenta electrostatic latent image bearer 10M, and the cyan image formed on a cyan electrostatic latent image bearer 10C. Then, the black image, the yellow image, the magenta image, and the cyan image are superimposed on the intermediate transferor 50 to form a composite color image (color transfer image).

On the other hand, in the paper feeding table 200, one of the paper feeding rollers 142 is selectively rotated to feed a sheet (recording paper) from one of the paper feeding cassettes 144 provided in multiple stages in a paper bank 143, the sheet is separated one by one by a separation roller 145 and delivered to a paper feed path 146, conveyed by a conveyance roller 147, guided to a paper feed path 148 in the copying apparatus main body 150, and then abutted against and stopped by a registration roller 49. Alternatively, the paper feeding roller 142 is rotated to feed a sheet (recording paper) from a manual feed tray 54, the sheet is separated one by one by the separation roller 145 and fed into a manual paper feed path 53, and is similarly abutted against and stopped by the registration roller 49. Although the registration roller 49 is generally used in a grounded state, it may be used with a bias applied thereto to remove paper dust from the sheet. Then, the registration roller 49 is rotated in synchronization with the composite color image (color transfer image) synthesized on the intermediate transferor 50, to deliver a sheet (recording paper) between the intermediate transferor 50 and the secondary transfer unit 22. By the secondary transfer unit 22 transferring (secondary transfer) the composite color image (color transfer image) onto the sheet (recording paper), a color image is transferred and formed on the sheet (recording paper). Note that the residual toner on the intermediate transferor 50 after the image transfer is cleaned by the intermediate transferor cleaning unit 17.

The sheet (recording paper) on which the color image is transferred and formed is conveyed by the secondary transfer unit 22 and delivered to the fixing device 25. In the fixing device 25, the composite color image (color transfer image) is fixed onto the sheet (recording paper) by heat and pressure. After that, the sheet (recording paper) is switched by a switching claw 55 and output by an output roller 56 to be stacked on a paper output tray 57. Alternatively, the sheet (recording paper) is switched by the switching claw 55, inverted by a sheet inverting device 28, and guided again to a transfer position. After an image is recorded on the back surface of the sheet (recording paper), the sheet (recording paper) is output by the output roller 56 and stacked on the paper output tray 57.

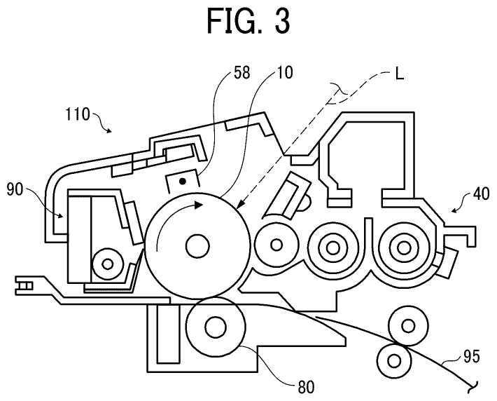

Next, an embodiment of the process cartridge is illustrated in FIG. 3. As illustrated in FIG. 3, a process cartridge 110 of the present embodiment incorporates an electrostatic latent image bearer 10, a charging unit 58 serving as a charging device, a developing unit 40 serving as a developing device, and a cleaning unit 90 serving as a cleaning device, and further has other devices as necessary. In FIG. 3, symbol L indicates exposure from an exposure device, and symbol 95 indicates recording paper.

The electrostatic latent image bearer 10 may be the same as the electrostatic latent image bearer used in the image forming apparatus. Any charging member is used for the charging unit 58.

Regarding the image forming process using the process cartridge illustrated in FIG. 3, while the electrostatic latent image bearer 10 rotates in the direction of the arrow, an electrostatic latent image corresponding to an exposure image is formed on its surface by charging with the charging unit 58 and exposure L by an exposure device.

This electrostatic latent image is developed with toner by the developing unit 40, and the toner development is transferred onto recording paper 95 by a transfer roller 80 and printed out. Subsequently, the surface of the electrostatic latent image bearer 10 after image transfer is cleaned by the cleaning unit 90, and the charge is further eliminated by a discharging device so as to repeat the above operations again.

According to the image forming apparatus and the image forming method according to embodiments of the present invention, since the toner according to an embodiment of the present invention, which is resistant to stress and excellent in low-temperature fixability, is used, high-quality images can be provided over a long period of time.

### EXAMPLES

Embodiments of the present invention will be described in more detail below with reference to examples and comparative examples, but the present invention is not limited thereto. Unless otherwise specified, “parts” and “%” in the following description represent “parts by mass” and “% by mass”, respectively.

### Example 1

### <Preparation of Amorphous Polyester Resins>

The monomers species described in Table 1 and tetrabutoxytitanate as a condensation catalyst were charged into a reaction vessel equipped with a cooling tube, a stirrer, and a nitrogen inlet tube. Under a nitrogen stream, the mixture was allowed to react at 230 °C for 6 hours while distilling off generated water. Next, the reaction was performed under a reduced pressure of 5 mmHg to 20 mmHg for 1 hour to obtain an amorphous polyester resin. In Table 1, “25 mol %” indicated by bisphenol A (2,2) propylene oxide represents the ratio in the alcohol component when the acid component is 50 mol % and the alcohol component is 50 mol %.

TABLE 1

| Acid component | Alcohol component | OH/COOH |
|---|---|---|
| Terephthalic acid | Bisphenol A (2,2) propylene | 1.1 |
| | oxide (25 mol %) | |
| | Bisphenol A (2,2) ethylene | |
| | oxide (25 mol %) | |

### <Preparation of Wax Dispersants>

Into an autoclave reaction vessel equipped with a stirring rod, a nitrogen inlet tube, and a thermometer, 368 parts by mass of xylene and 158 parts by mass of an ethylene-propylene copolymer (softening point: 74 °C) were charged, and the temperature was raised to 165 °C. Thereafter, a solution prepared by dissolving 55 parts by mass of t-butyl peroxybenzoate as a polymerization initiator in a mixture of 846 parts by mass of styrene, 32 parts by mass of 2-ethylhexyl acrylate, and 15 parts by mass of maleic anhydride was added dropwise over 5 hours, and then the mixture was maintained under stirring for 1 hour. Subsequently, the solvent removal was performed to obtain a wax dispersant. The obtained wax dispersant had a weight-average molecular weight of 25,000, a glass transition point of 65 °C, and an acid value of 8 mg KOH/g.

### <Preparation of Toner Base Particles>

After premixing toner raw materials having the following composition for 10 minutes using a Henschel mixer (FM20B, manufactured by Nippon Coke & Engineering Co., Ltd.), the mixture was melted and kneaded at a temperature of 100 °C to 130 °C with a single-screw kneader (Buss Co-Kneader, manufactured by Buss). After cooling the obtained kneaded material to room temperature, it was coarsely pulverized to a size of 200 μm to 300 μm using a Rotoplex. Subsequently, the kneaded material was finely pulverized using a counter jet mill (100AFG, manufactured by Hosokawa Micron Corporation) while appropriately adjusting the grinding air pressure so that the weight-average particle diameter was 5.4±0.3 μm. The resulting powder was then classified using an air classifier (EJ-LABO, manufactured by Matsubo Corp.) while appropriately adjusting the louver opening so that the weight-average particle diameter was 5.8±0.4 μm and the ratio of weight-average particle diameter of the number-average particle diameter was not more than 1.25, thereby obtaining toner base particles.

### —Composition—

Amorphous polyester resin: 90.0 parts
Fischer-Tropsch wax (FNP-0090, manufactured by Nippon Seiro Co., Ltd.): 1.6 parts
Carbon black (C-44, manufactured by Mitsubishi Chemical Corporation): 5.0 parts
Quaternary ammonium salt (PBE-51, manufactured by Orient Chemical Industries Co., Ltd.): 0.4 parts
Wax dispersant: 2.0 parts
Azo iron compound (PT-700, manufactured by Hodogaya Chemical Co., Ltd.): 1.0 parts

### <Preparation of Toner>

1.5 parts of hydrophobic silica (NY50L, manufactured by Nippon Aerosil Co., Ltd., oil-treated silica having an average particle size of 30 nm) was added to 100 parts of toner base particles, and then stirred and mixed using a Henschel mixer to obtain a toner. Using this toner, low-temperature fixability and heat-resistant storage stability were evaluated by the following evaluation methods.

<Analysis by Fourier Transform Infrared Spectroscopy with Attenuated Total Reflectance (FTIR-ATR)>

The toner was analyzed by the ATR method using FT-IR, and the maximum peak height R1 of the spectrum in the range of 743 to 890 cm⁻¹, the maximum peak height R2 of the spectrum in the range of 685 to 711 cm⁻¹, and the maximum peak height W of the spectrum in the range of 2834 to 2862 cm⁻¹ were measured.

### <Evaluation of Low-Temperature Fixability>

The toner was loaded into a copier (RICOH MP C 6003) manufactured by Ricoh Co., Ltd., and images was output. A solid image having an adhesion amount of 0.4 mg/cm² was output on paper (Type 6200, manufactured by Ricoh Co., Ltd.) through exposure, development, and transfer steps. The fixing linear speed was 256 mm/sec. Image were output while sequentially changing the fixing temperature in 5 °C increments, the lower limit temperature at which cold offset does not occur (minimum fixing temperature: low-temperature fixability) was measured, and evaluated according to the following evaluation criteria. The NIP width of the fixing device was 11 mm.

### [Evaluation Criteria]

Excellent: The fixing temperature is not more than 140 °C.
Good: The fixing temperature is more than 140 °C and not more than 145 °C.
Fair: The fixing temperature is more than 145 °C and not more than 150 °C.
Poor: The fixing temperature is more than 150 °C.

Evaluations of Excellent, Good and Fair can be judged to be practically sufficient results.

### <Evaluation of Heat-Resistant Storage Stability>

Toner base particles were stored under 50 °C conditions for 24 hours, and the penetration was measured in accordance with JIS K2235 (25 °C). A penetrometer VR-5610 (Shimadzu Corporation) was used as a penetration tester.

### [Evaluation Criteria]

Excellent: Not less than 4.0 mm.
Good: Not less than 1.0 mm and less than 4.0 mm.
Fair: Not less than 0.5 mm and less than 1.0 mm.
Poor: Less than 0.5 mm.

Evaluations of Excellent, Good and Fair can be judged to be practically sufficient results.

### Examples 2 to 6, Comparative Examples 1 to 3

Toners were prepared and evaluated in the same manner as in Example 1, except that the toner composition was changed to the composition listed in Table 2. The evaluation results are listed in Table 3.

TABLE 2

| | | Wax dispersant | | | | |
|---|---|---|---|---|---|---|
| | | Amount | | Release agent | | |
| | | added | | | Amount | |
| | | [parts | | | added | |
| | Toner | by | | | [parts by | |
| | name | mass] | R2/R1 | Type | mass] | W/R1 |
| Example 1 | Toner 1 | 2.0 | 0.085 | Fischer-Tropsch wax | 1.6 | 0.046 |
| Example 2 | Toner 2 | 2.0 | 0.091 | Fischer-Tropsch wax | 2.0 | 0.054 |
| Example 3 | Toner 3 | 2.3 | 0.094 | Fischer-Tropsch wax | 1.6 | 0.038 |
| Example 4 | Toner 4 | 1.6 | 0.076 | Fischer-Tropsch wax | 1.6 | 0.065 |
| Example 5 | Toner 5 | 2.0 | 0.079 | Fischer-Tropsch wax | 1.4 | 0.035 |
| Example 6 | Toner 6 | 2.0 | 0.089 | Ester wax | 1.6 | 0.049 |
| Comparative | Toner 7 | 2.5 | 0.096 | Fischer-Tropsch wax | 1.6 | 0.033 |
| example 1 | | | | | | |
| Comparative | Toner 8 | 0 | 0 | Fischer-Tropsch wax | 1.6 | 0.075 |
| example 2 | | | | | | |
| Comparative | Toner 9 | 1.2 | 0.042 | Fischer-Tropsch wax | 1.2 | 0.042 |
| example 3 | | | | | | |

TABLE 3

| | | Evaluation | |
|---|---|---|---|
| | | Low-temperature | Heat-resistant |
| | Toner name | fixability | storage stability |
| Example 1 | Toner 1 | Excellent | Excellent |
| Example 2 | Toner 2 | Good | Excellent |
| Example 3 | Toner 3 | Good | Fair |
| Example 4 | Toner 4 | Fair | Good |
| Example 5 | Toner 5 | Excellent | Fair |
| Example 6 | Toner 6 | Fair | Fair |
| Comparative | Toner 7 | Poor | Good |
| example 1 | | | |
| Comparative | Toner 8 | Poor | Good |
| example 2 | | | |
| Comparative | Toner 9 | Excellent | Poor |
| example 3 | | | |

From the results of Examples 1 to 6, it can be seen that Toners 1 to 6, which have a ratio (R2/R1) of not less than 0.075 and not more than 0.095 and a ratio (W/R1) of not less than 0.035 and not more than 0.065, achieve both excellent low-temperature fixability and heat-resistant storage stability. On the other hand, from the results of Comparative Examples 1 to 3, it is found that Toners 7 to 9, which do not satisfy at least one of the conditions that: a ratio (R2/R1) is not less than 0.075 and not more than 0.095; or a ratio (W/R1) is not less than 0.035 and not more than 0.065, fail to achieve both low-temperature fixability and heat-resistant storage stability.

While the embodiments of the present invention have been described above, the present invention is not limited to specific embodiments, and various modifications and changes are possible within the scope of the invention described in the claims.

For example, embodiments of the present invention include the following aspects.

In a first aspect, a toner comprises a polyester resin, a styrene resin, and a release agent,
wherein, in a spectrum of the toner as determined by Fourier transform infrared spectroscopy with attenuated total reflectance (FTIR-ATR), a ratio R2/R1 is not less than 0.075 and not more than 0.095 and a ratio W/R1 is not less than 0.035 and not more than 0.065, where R1 is a maximum peak height of the spectrum in a range of 743 to 890 cm⁻¹, R2 is a maximum peak height of the spectrum in a range of 685 to 711 cm⁻¹, and W is a maximum peak height of the spectrum in a range of 2834 to 2862 cm⁻¹.

According to a second aspect, in the toner according to the first aspect, the styrene resin has a glass transition temperature of not less than 60 °C.

According to a third aspect, in the toner according to any one of the first aspect to the second aspect, the release agent comprises a Fischer-Tropsch wax.

According to a fourth aspect, a method for producing the toner according to any one of the first aspect to the third aspect includes:
kneading and melting toner materials to obtain a kneaded material;
pulverizing the kneaded material to obtain a pulverized product;
classifying the pulverized product to obtain toner base particles; and
adding an external additive to the toner base particles.

According to a fifth aspect, a toner container unit includes the toner according to any one of the first aspect to the third aspect and a container storing the toner.

According to a sixth aspect, an image forming apparatus includes:
an electrostatic latent image bearer;
an electrostatic latent image forming device to form an electrostatic latent image on the electrostatic latent image bearer;
a developing device to develop the electrostatic latent image formed on the electrostatic latent image bearer with the toner according to any one of the first aspect to the third aspect to form a visible image;
a transfer device to transfer the visible image formed on the electrostatic latent image bearer onto a surface of a recording medium; and
a fixing device to fix the visible image transferred onto the surface of the recording medium.

According to a seventh aspect, an image forming method includes:
forming an electrostatic latent image on an electrostatic latent image bearer;
developing the electrostatic latent image formed on the electrostatic latent image bearer with the toner according to any one of the first aspect to the third aspect to form a visible image;
transferring the visible image formed on the electrostatic latent image bearer onto a surface of a recording medium; and
fixing the visible image transferred onto the surface of the recording medium.

According to an eighth aspect, a method for producing printed matter includes: forming a toner image on a recording medium using the image forming apparatus of the sixth aspect.

The toner according to the first aspect to the third aspect, the method for producing the toner according to the fourth aspect, the toner container unit according to the fifth aspect, the image forming apparatus according to the sixth aspect, the image forming method according to the seventh aspect, and the method for producing printed matter according to the eighth aspect can solve the conventional problems and achieve the object of the present invention.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A toner comprising:
a polyester resin;
a styrene resin; and
a release agent,
wherein, in a spectrum of the toner as determined by Fourier transform infrared spectroscopy with attenuated total reflectance, a ratio R2/R1 is not less than 0.075 and not more than 0.095 and a ratio W/R1 is not less than 0.035 and not more than 0.065, where R1 is a maximum peak height of the spectrum in a range of 743 to 890 cm⁻¹, R2 is a maximum peak height of the spectrum in a range of 685 to 711 cm⁻¹, and W is a maximum peak height of the spectrum in a range of 2834 to 2862 cm⁻¹.

2. The toner according to claim 1, wherein the styrene resin has a glass transition temperature of not less than 60 °C.

3. The toner according to claim 1, wherein the release agent comprises a Fischer-Tropsch wax.

4. A method for producing the toner according to claim 1, the method comprising:
kneading and melting toner materials to obtain a kneaded material;
pulverizing the kneaded material to obtain a pulverized product;
classifying the pulverized product to obtain toner base particles; and
adding an external additive to the toner base particles.

5. A toner container unit comprising:
the toner according to claim 1; and
a container storing the toner.

6. An image forming apparatus comprising:
an electrostatic latent image bearer;
an electrostatic latent image forming device to form an electrostatic latent image on the electrostatic latent image bearer;
a developing device to develop the electrostatic latent image formed on the electrostatic latent image bearer with the toner according to claim 1 to form a visible image;
a transfer device to transfer the visible image formed on the electrostatic latent image bearer onto a surface of a recording medium; and
a fixing device to fix the visible image transferred onto the surface of the recording medium.

7. An image forming method comprising:
forming an electrostatic latent image on an electrostatic latent image bearer;
developing the electrostatic latent image formed on the electrostatic latent image bearer with the toner according to claim 1 to form a visible image;
transferring the visible image formed on the electrostatic latent image bearer onto a surface of a recording medium; and
fixing the visible image transferred onto the surface of the recording medium.

8. A method for producing printed matter, comprising:
forming a toner image on a recording medium using the image forming apparatus according to claim 6.
